(19) United States
(12) Patent Application Publication
(10) Pub. No.: US 2018/0150766 A1
(43) Pub. Date: May 31, 2018

(54) CLASSIFICATION METHOD BASED ON SUPPORT VECTOR MACHINE

(71) Applicant: Daegu Gyeongbuk Institute of Science and Technology, Dalseong-gun (KR)

(72) Inventors: Min Kook CHOI, Daegu (KR); Soon KWON, Daegu (KR); Woo Young JUNG, Daegu (KR); Hee Chul JUNG, Daegu (KR)

(73) Assignee: Daegu Gyeongbuk Institute of Science and Technology, Dalseong-gun (KR)

(21) Appl. No.: 15/614,815

(22) Filed: Jun. 6, 2017

(30) Foreign Application Priority Data
Nov. 30, 2016 (KR) 10-2016-0161797

(51) Int. Cl. G06N 99/00; G06N 5/02

(52) U.S. Cl. CPC G06N 99/005; G06N 5/022

(57) ABSTRACT

Provided is a classification method based on a support vector machine, which is effective for a small amount of training data. The classification method based on a support vector machine includes building a first classification model by applying a weight value based on a geometrical distribution of an input feature vector, building a second classification model, based on a classification uncertainty of the input feature vector, and merging the first classification model and the second classification model to perform dual optimization.

### CROSS-REFERENCE TO RELATED APPLICATIONS

This application claims priority under 35 U.S.C. § 119 to Korean Patent Application No. 10-2016-0161797, filed on Nov. 30, 2016, the disclosure of which is incorporated herein by reference in its entirety.

### TECHNICAL FIELD

The present invention relates to a classification method based on a support vector machine (SVM), and more particularly, to a classification method effective for a small amount of training data.

### BACKGROUND

A SVM is a type of classifier using a hyperplane, and a maximum margin classifier SVM performs clear classification between a positive feature vector and a negative feature vector.

However, the SVM is effective in a case where a data set is sufficiently large, and when only a small number of samples are available, the SVM is greatly affected by an outlier.

### SUMMARY

Accordingly, the present invention provides an SVM-based classification method effective for a small amount of training data.

The present invention also provides an SVM-based classification method which assigns a weight value based on a geometrical distribution of each of feature vectors and configures a final hyperplane by using a classification uncertainty of each feature vector, thereby enabling efficient classification by using a small amount of data.

In one general aspect, a classification method based on a support vector machine includes building a first classification model by applying a weight value based on a geometrical distribution of an input feature vector, building a second classification model, based on a classification uncertainty of the input feature vector, and merging the first classification model and the second classification model to perform dual optimization.

Other features and aspects will be apparent from the following detailed description, the drawings, and the claims.

### BRIEF DESCRIPTION OF THE DRAWINGS

FIG. 1 is a flowchart illustrating an SVM-based classification method according to an embodiment of the present invention.

FIG. 2A through FIG. 2D are diagrams showing results obtained by comparing an SVM model of the related art with an SVM model according to an embodiment of the present invention.

FIG. 3A and FIG. 3B are diagrams showing weight extraction and classification uncertainty extraction according to an embodiment of the present invention.

FIG. 4A and FIG. 4B are diagrams showing an experiment result for setting parameters, according to an embodiment of the present invention.

FIG. 5A and FIG. 5B are diagrams showing a classification result of an MNIST data set according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter.

However, the present invention may be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

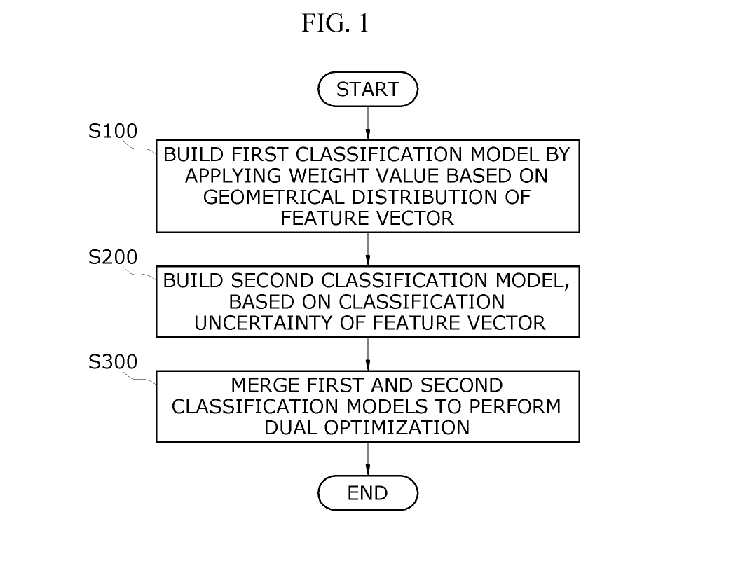

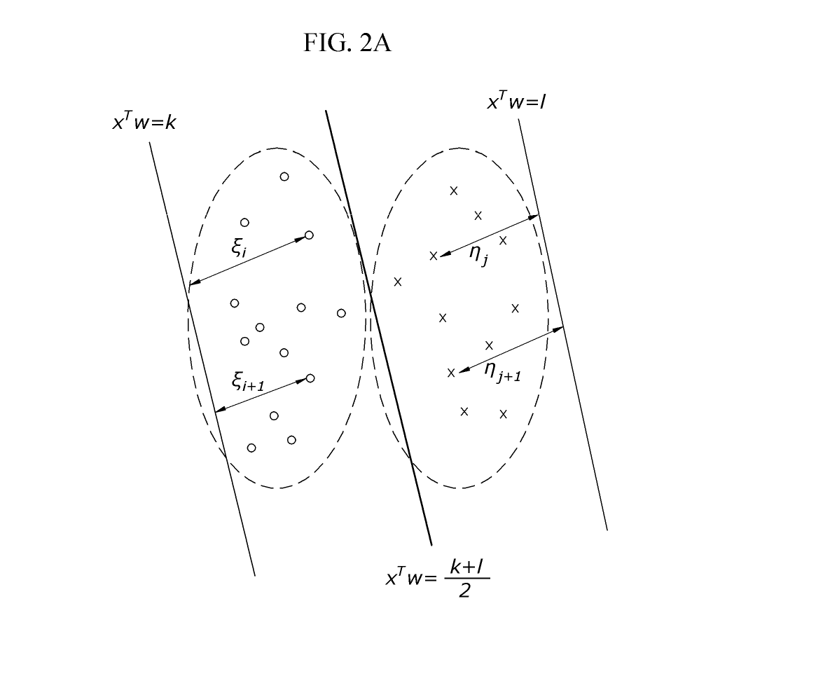

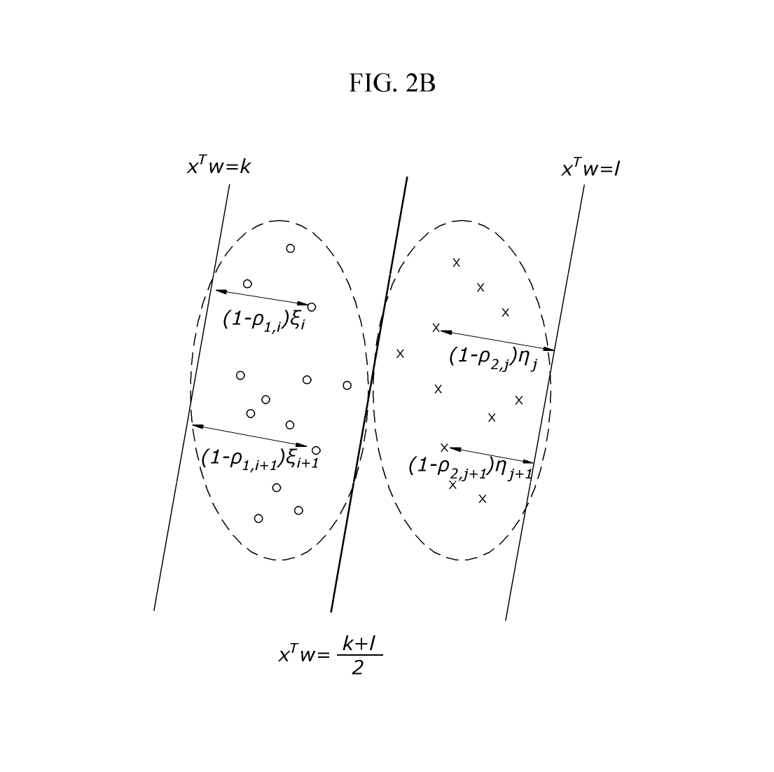

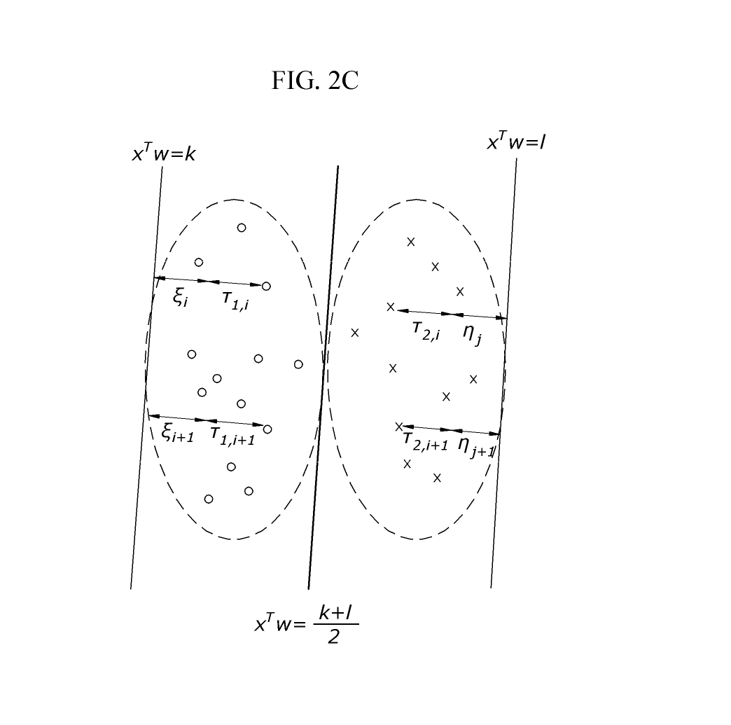

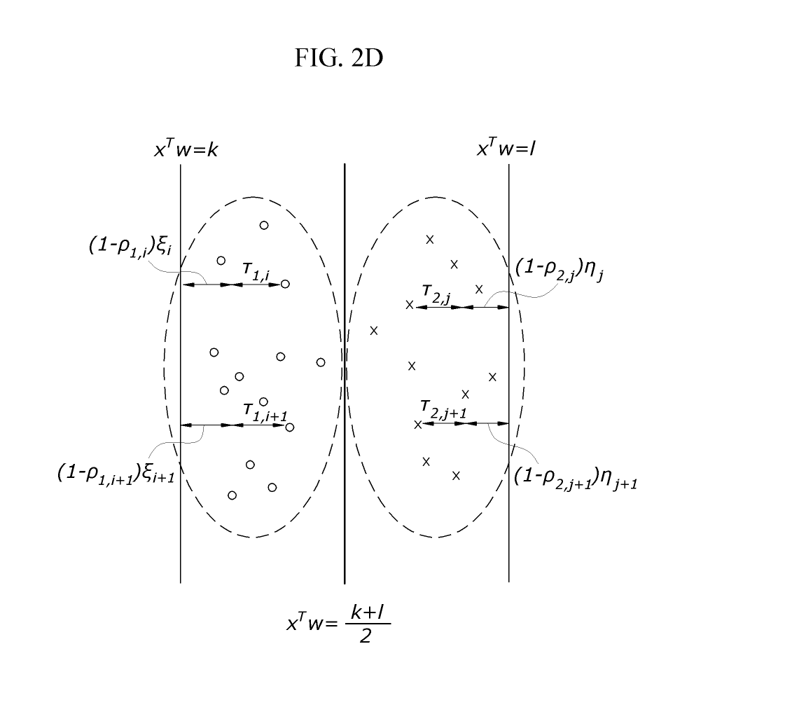

FIG. 1 is a flowchart illustrating an SVM-based classification method according to an embodiment of the present invention. FIG. 2A through FIG. 2D are showing results obtained by comparing an SVM model of the related art with an SVM model according to an embodiment of the present invention.

Before describing an embodiment of the present invention, an SVM model of the related art will be first described for heling understanding of those skilled in the art.

A maximum margin classifier SVM denotes a classifier for detecting a linear determination boundary having a maximum margin. However, as described above, the classification reliability of such a model is reduced by a number of outliers when the number of training samples is small.

In order to solve such a problem, an SVM having a slack variable and a soft margin SVM using a kernel method have been proposed to allow slight misclassification.

The SVM-based classification method according to an embodiment of the present invention may use a reduced convex hulls-margin (RC-margin) of an SVM for maximizing a soft margin.

When n number of items of training data are assumed, n number of feature vectors for binary classifier training may be assigned as a positive class “A_{p×n}_{₁}=[x₁, x₂, . . . , xₙ_{₁}]” and a negative class “B_{p×n}_{₂}=[x₁, x₂, . . . , nₙ_{₂}]”, may be n₁+n₂ (n=n₁+n₂), and one feature vector “xϵ [symbol] ^{1×p}” may be defined as a column vector having a size “p”.

In this case, a primal optimization of a hyperplane dividing a shortest distance between reduced convex hulls (RCHs) of two classes for soft margin classification may be defined as expressed in the following Equation (1):

$${min}_{w , ξ , η , k , l} \frac{1}{2} {w}^{T} w - k + l + C ( {ξ}^{T} e + {η}^{T} e ) , \\ s . t . \\ \begin{matrix}{A}^{T} w - ke + ξ \geq 0 , & ξ \geq 0 \\ - {B}^{T} w + le + η \geq 0 , & η \geq 0\end{matrix} \qquad ( 1 )$$

where k and l each denote an offset value of a hyperplane and satisfy x^{T}w=(k+1)/2, and ξ_{1×n}_{₁} and η_{1×n}_{₂} each denote a slack variable for providing a soft margin. Also, e denotes a column vector having all elements as 1, and C denotes a regularization parameter for controlling reduction of a convex hull.

In this case, a valid range of C may be assigned as 1/M≤C≤1 when M=min(n₁, n₂).

Hereinafter, an operation (S100) of building a weight model (a first classification model) for an RC margin SVM will be described.

According to an embodiment of the present invention, in order to impose a misclassification penalty robust to an assigned feature vector, a weight value may be obtained based on a geometrical position and distribution of each feature vector which is a training sample.

A geometrical distribution-based penalty can sensitively react on an outlier, and thus, it is possible to configure a more effective hyperplane from limited training data.

A weight vector may be defined as ρ_{y}, ρ_{(y,i)} may be assigned for an i^{th} feature vector included in a class “y”, and a primal optimization of a weight model based on an RC-margin may be defined as expressed in the following Equation (2):

$${min}_{w , ξ , η , k , l} \frac{1}{2} {w}^{T} w - k + l + D ( {ξ}^{T} ( e - {ρ}_{1} ) + {η}^{T} ( e - {ρ}_{2} ) ) , \\ s . t . \\ \begin{matrix}{A}^{T} w - ke + ξ \geq 0 , & ξ \geq 0 \\ - {B}^{T} w + le + η \geq 0 , & η \geq 0\end{matrix} \qquad ( 2 )$$

where ρ₁ϵ [symbol] ⁿ^{₁}^{×1} and ρ₂ϵ [symbol] ⁿ^{₂}^{×1} each denotes a weight vector and respectively satisfy normalization conditions “Σᵢ₌₁ⁿ^{₁} ρ_{1,i}=1” and “Σᵢ₌₁ⁿ^{₂} ρ_{2,i}=1”.

In this case, a weighting parameter “D” may have a value of 1/M≤D≤1 as in the RC-margin.

According to an embodiment of the present invention, in order to extract a weight vector “ρ” for a feature vector, a normalized nearest neighbor distance for each feature vector may be extracted as a weight value.

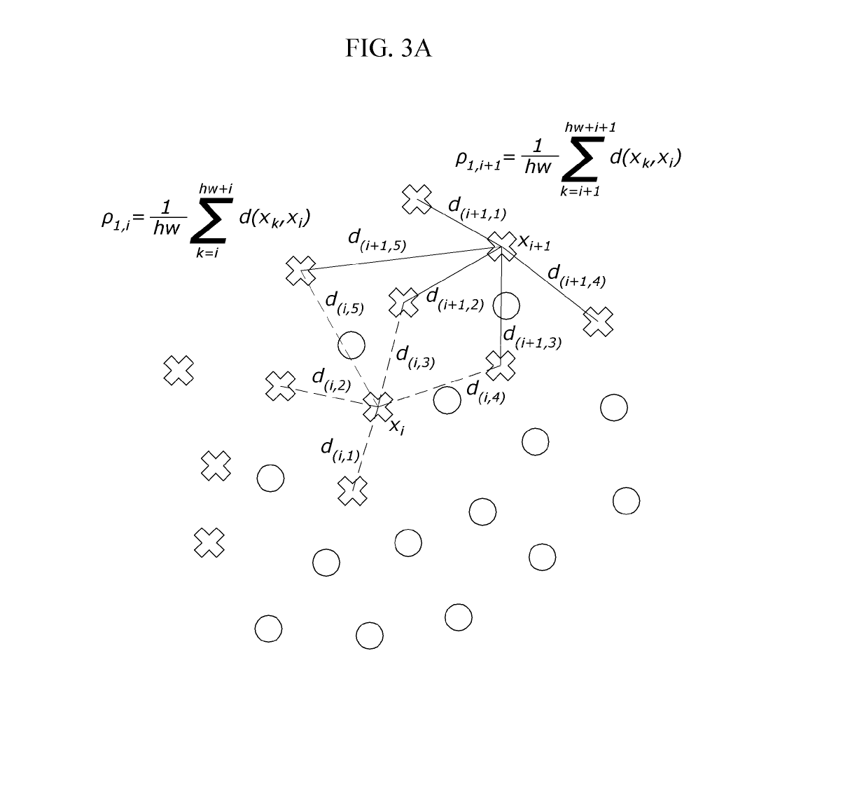

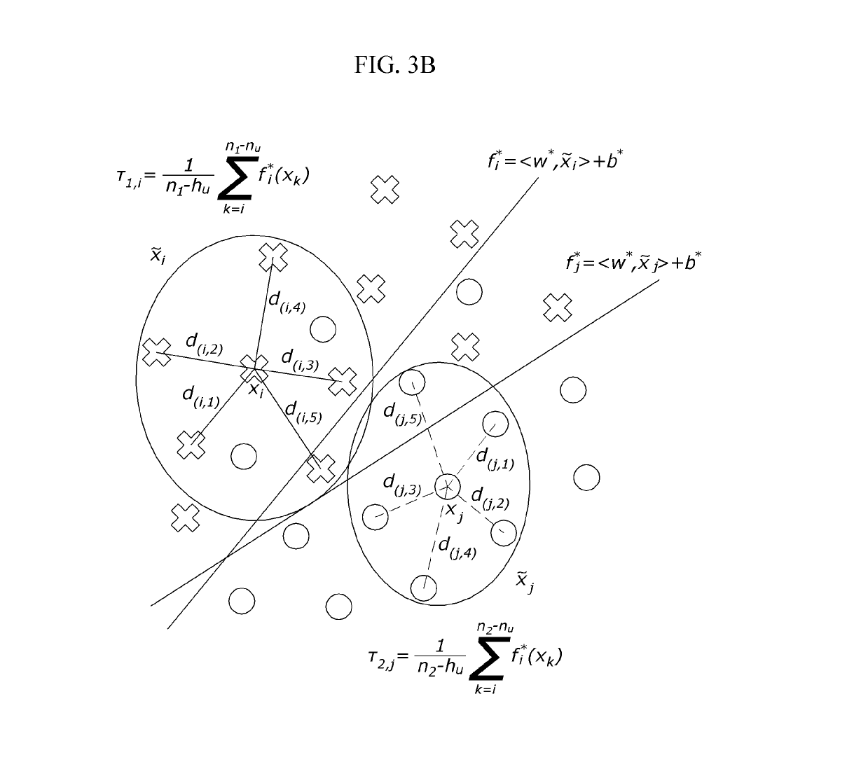

Moreover, ρ_{1,i} for an ith feature vector included in a class “A” may be calculated as an average L₂ distance of h_{w} number of proximity feature vectors located at a nearest position as expressed in the following Equation (3):

$${ρ}_{1 , i} = \frac{1}{{h}_{w}} {\sum }_{k = j}^{j + {h}_{w}} d ( {x}_{i} , {x}_{j} ) , i \neq j \qquad ( 3 )$$

where d(xᵢ, xⱼ) denotes an L₂ distance between two feature vectors “xᵢ” and “xⱼ”. A weight value may be extracted for ρ_{2,i} in a similar method, and FIG. 3A shows an example of extracting a weight value when h_{w}=5.

Hereinafter, an operation (S200) of building an RC-margin model (a second classification model) based on classification uncertainty will be described.

The classification uncertainty may be defined as an approximate classification certainty for an opposing class of a specific feature vector.

By reflecting the classification uncertainty in a model, different weight values may be assigned based on a level of contribution of each feature vector which is made in an actual classification process.

When a classification uncertainty vector for a feature vector in the class “y” is τ_{y}, a classification uncertainty of the i^{th} feature vector may be defined as τ_{(y,i)}.

In this case, the RC-margin model having the classification uncertainty as a penalty may be expressed as the following Equation (4):

$${min}_{w , ξ , η , k , l} \frac{1}{2} {w}^{T} w - k + l + E ( {ξ}^{T} e + {η}^{T} e ) , \\ s . t . \\ \begin{matrix}{A}^{T} w + {τ}_{1} - ke + ξ \geq 0 , & ξ \geq 0 \\ - {B}^{T} w + {τ}_{2} + le + η \geq 0 , & η \geq 0\end{matrix} \qquad ( 4 )$$

where τ₁ and τ₂ each denote a classification uncertainty vector and respectively have a dimension of n₁×1 land a dimension of n₂×1.

A weighting parameter “E” may control a size of a convex hull and may have a range of 1/M≤E≤1.

A classification uncertainty “τ_{2(y,i)}” may be assigned as a normalized value of a classification uncertainty of a specific feature vector.

A local linear classifier, which has hᵤ number of feature vector sets having a nearest neighbor distance with respect to a feature vector “x” having a specific class and is for an opposite class may establish fᵢ⁺=<w⁺, \tilde{x}>+b̂, and a classification uncertainty may be measured through an established local classifier.

The classifier may perform training on the hᵤ feature vectors having the nearest neighbor distance with respect to the i^{th} feature vector, and a classification uncertainty of the i^{th} feature vector may be estimated as expressed in the following Equation (5):

$${τ}_{1 , i} = \frac{1}{{n}_{1} - {h}_{u}} {\sum }_{k = 1}^{{n}_{1} - {h}_{u}} {f}_{i}^{*} ( {x}_{k} ) \qquad ( 5 )$$

A classification uncertainty vector of an opposite class for classification uncertainty estimation may be estimated in a similar method, and each uncertainty vector “τ” may be normalized as a value between 0 and 1. FIG. 3B shows an example when hᵤ=5.

Hereinafter, an operation (S300) of optimizing a mergence model for the first classification model and the second classification model will be described.

In order to obtain all of advantages of the first classification model and the second classification model, the operation (S300) according to an embodiment of the present invention may finally derive Equation (6) from Equations (2) and (4) for primal optimization of the first classification model and the second classification model:

$${min}_{w , ξ , η , k , l} \frac{1}{2} {w}^{T} w - k + l + Q ( {ξ}^{T} ( e - {ρ}_{1} ) + {η}^{T} ( e - {ρ}_{2} ) ) , \\ s . t . \\ \begin{matrix}{A}^{T} w + {τ}_{1} - ke + ξ \geq 0 , & ξ \geq 0 \\ - {B}^{T} w + {τ}_{2} + le + η \geq 0 , & η \geq 0\end{matrix} \qquad ( 6 )$$

A merged weighting parameter “Q” may control a size of a convex hull and may have a range of 1/M≤Q≤1 as a valid range.

In order to obtain a solution to a final primal optimization problem of Equation (6), by applying non-negative Lagrangian multiplier vectors “μₙ_{₁}_{×1}, γₙ_{₁}_{×1}, νₙ_{₂}_{×1}, ζₙ_{₂}_{×1}” for each optimization variable, partial differentiation may be performed as expressed in the following Equation (7):

$${min}_{w , ξ , η , μ , γ , v , ζ , k , l} L ( w , ξ , η , μ , γ , v , ζ , k , l ) = \frac{1}{2} {w}^{T} w - k + l + Q ( {ζ}^{T} ( e - {ρ}_{2} ) + {η}^{T} ( e - {ρ}_{2} ) ) - {μ}^{T} ( {A}^{T} w + {τ}_{1} - ke + ζ ) - {v}^{T} ( - {B}^{T} w + {τ}_{2} - le + η ) - {γ}^{T} ξ - {ζ}^{T} η , \\ s . t . \frac{\partial L}{\partial w} = w - {A}^{T} μ + {B}^{T} v = 0 , \\ \begin{matrix}\frac{\partial L}{\partial k} = - 1 + {μ}^{T} e = 0 , & μ \geq 0 \\ \frac{\partial L}{\partial l} = - 1 - {v}^{T} e = 0 , & v \geq 0 \\ \frac{\partial L}{\partial ξ} = Q ( e - {ρ}_{1} ) - μ - γ = 0 , & γ \geq 0 \\ \frac{\partial L}{\partial η} = Q ( e - {ρ}_{2} ) - v - η = 0 , & η \geq 0\end{matrix} \qquad ( 7 )$$

An optimization function having a simplified dual form may be obtained by substituting a partial differentiation result “w=A^{T} μ−B^{T} ν, γ=Qρ₁−μ, ζ=Qρ₂−ν” into a predetermined equation, and a predetermined function may be defined as a solution for detecting a shortest distance of a convex hull, on which a penalty is imposed, as expressed in the following Equation (8):

$${max}_{w , ξ , η , k , l} - \frac{1}{2} {‖ {A}^{T} μ - {B}^{T} v ‖}^{2} - ( {ζ}_{1}^{T} μ + {ζ}_{2}^{T} v ) , \\ s . t . \\ \begin{matrix}{μ}^{T} e - 1 = 0 , & 1 - {v}^{T} e = 0 , \\ 0 \leq ( 1 - {ρ}_{1 , i} ) {μ}_{i} \leq Q , & 0 \leq ( 1 - {ρ}_{2 , i} ) {v}_{i} \leq Q\end{matrix} \qquad ( 8 )$$

where A^{T} μ and B^{T} ν each denote a convex hull of each of feature vectors, and a weighting parameter “Q” controls the convex hull to an upper bound of (1−ρ_{2,i}) νᵢ of (1−ρ_{1,i})μᵢ of a weighted coefficient “(1−ρ_{1,i})μᵢ”.

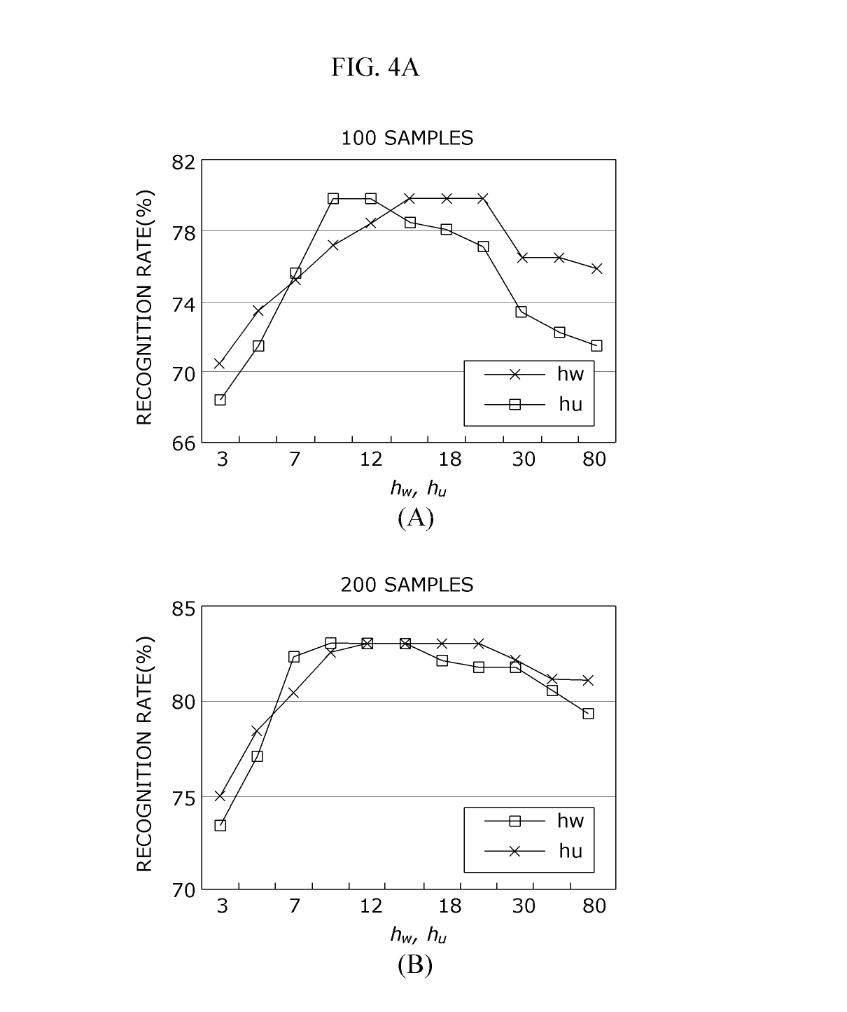

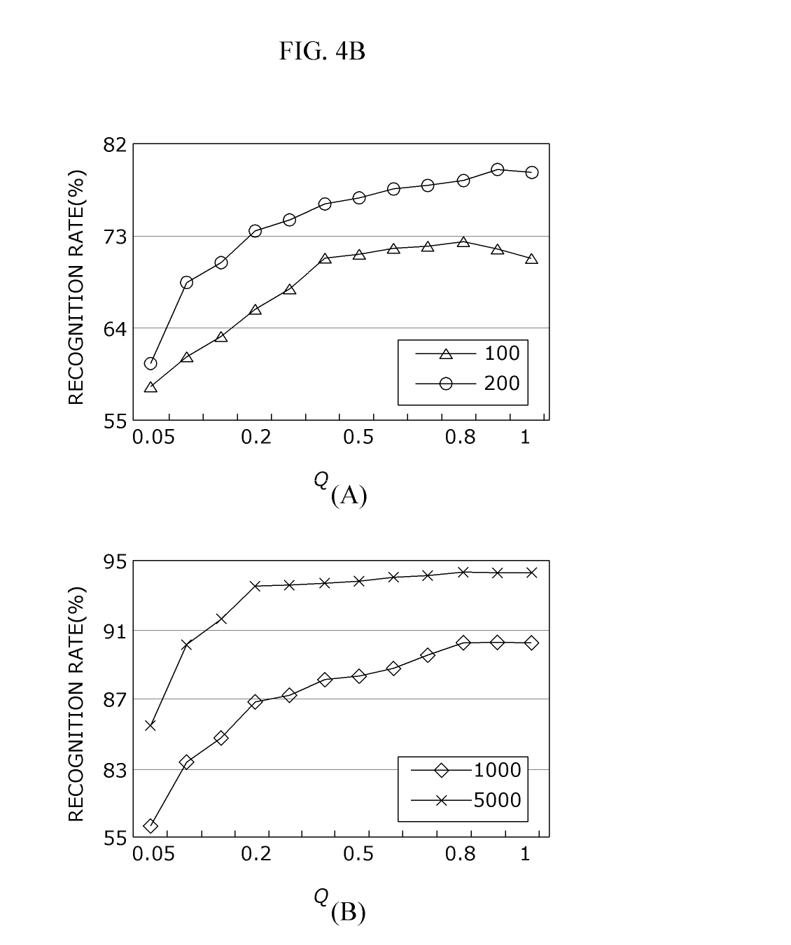

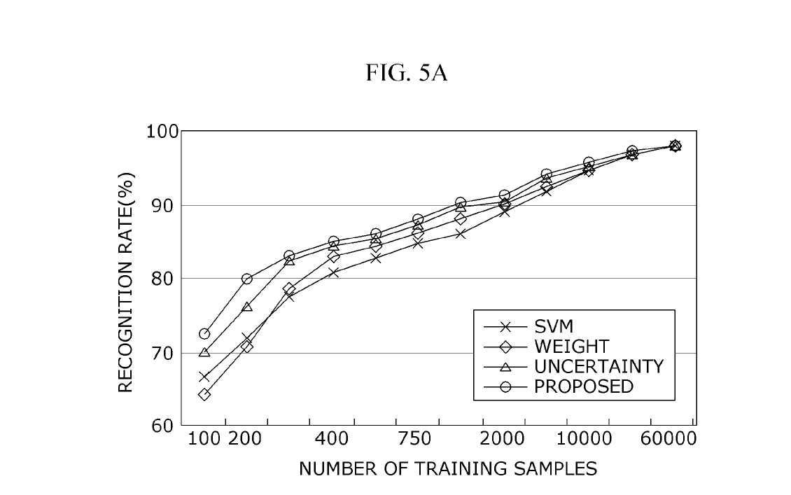

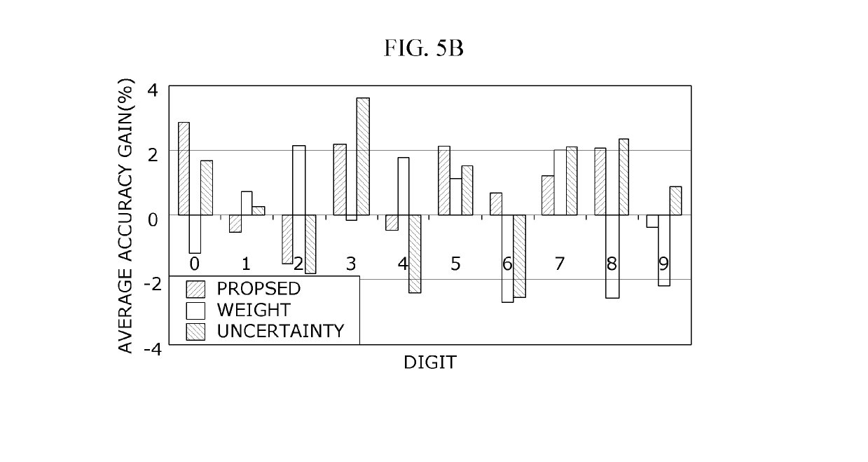

FIG. 4A, FIG. 4B, FIG. 5A and FIG. 5B are diagrams showing experiment results according to an embodiment of the present invention.

FIG. 4A shows h_{w} and hᵤ when a parameter “Q” is fixed to 0.9, and FIG. 4B shows a variation of the parameter “Q” when h_{w}=9 and hᵤ=15.

FIG. 5A and FIG. 5B are diagrams showing a result of digit recognition. FIG. 5A shows a classification result obtained by measuring SVM, weight, and uncertainty with an SVM model and a classification model according to an embodiment of the present invention with respect to the number of different training data. FIG. 5B shows a result obtained by classifying 200 pieces of training data.

According to an embodiment of the present invention, it can be seen that when the number of pieces of training data is small, performance is very high.

The SVM-based classification method according to the embodiments of the present invention may reflect a structural form of each of input feature vectors in addition to a criterion for maximizing a soft margin of a related art SVM model, thereby enhancing model performance. Also, the SVM-based classification method according to the embodiments of the present invention may measure a classification capacity of each of the input feature vectors to impose a strong penalty on a feature vector which is small in classification capacity, thereby building a model robust to noise.

According to the embodiments of the present invention, a classification model to which a weight value based on a geometrical distribution of a feature vector is applied may be built, a classification model based on a classification uncertainty of a feature vector may be built, and dual optimization for merging two classification models may be provided, thereby enabling an efficient SVM model to be realized by using a small amount of data.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A classification method based on a support vector machine, the classification method comprising:
(a) building a first classification model by applying a weight value based on a geometrical distribution of an input feature vector;
(b) building a second classification model, based on a classification uncertainty of the input feature vector; and
(c) merging the first classification model and the second classification model to perform dual optimization.

2. The classification method of claim 1, wherein step (a) comprises reflecting a structural form of the input feature vector and a criterion for maximizing a soft margin, and obtaining the weight value by using a geometrical position and distribution.

3. The classification method of claim 1, wherein step (a) comprises obtaining a weight vector satisfying a normalization condition, using a first weighting parameter, and extracting a normalized nearest neighbor distance as a weight value for the input feature vector.

4. The classification method of claim 1, wherein step (b) comprises considering the classification uncertainty where different weight values are assigned based on a level of contribution of the input feature vector in a classification operation, using a second weighting parameter for controlling a size of a convex hull, and establishing a local linear classifier for an opposite class by using a predetermined number of feature vector sets to measure the classification uncertainty.

5. The classification method of claim 1, wherein step (c) comprises using a merged third weighting parameter for controlling a size of a convex hull, and performing dual optimization with a non-negative Lagrangian multiplier.

6. The classification method of claim 1, wherein step (c) comprises calculating a dual optimization function by using a penalty based on a geometrical distribution in the first classification model and a penalty based on a geometrical distribution in the second classification model, and providing a solution based on the dual optimization function to build a classification model.
